(19) United States
(12) Patent Application Publication
(10) Pub. No.: US 2013/0325518 A1
(43) Pub. Date: Dec. 5, 2013

(54) PROCESS, METHOD AND SYSTEM FOR OBTAINING INSURANCE QUOTES AND GENERATING A DECLARATION PAGE

(71) Applicant: Christopher Glynn R. Hunter, Woodstock, GA (US)

(72) Inventor: Christopher Glynn R. Hunter, Woodstock, GA (US)

(21) Appl. No.: 13/907,707

(22) Filed: May 31, 2013

Related U.S. Application Data
(60) Provisional application No. 61/654,751, filed on Jun. 1, 2012.

(51) Int. Cl. G06Q 40/08; G06Q 50/16

(52) U.S. Cl. CPC G06Q 40/08; G06Q 50/16
USPC 705/4

(57) ABSTRACT

This is a system including the process, methods, instructions and architecture of a graphical user interface saved on a physical, computer readable media device and run to allow homebuyers and or their lenders to obtain insurance quotes and to print or email Declaration Pages locally.

### PRIORITY CLAIM

The present nonprovisional application, to the fullest extent permissible by law, claims priority to and the benefit of U.S. Provisional Application No. 61/654,751 filed on Jun. 1, 2012, inventor Christopher Glynn R. Hunter, entitled “Process, Instructions and Architecture of a Graphical User Interface Saved on a Physical, Computer Read-Able Media Device And Run To Allow Buyers and I or Their Loan Officers to Obtain Home Insurance Quotes And Print or Email Declaration Pages Locally”, which is hereby incorporated herein.

### TECHNICAL FIELD

The present invention relates generally to the process, method and system of insurance quoting and more specifically to a process, method and system of collecting user information including the subject item(s) to be insured, obtaining data regarding the subject item(s), compiling said user information and said subject item(s) data to obtain insurance quotes and then upon selection the creation and printing of a Declaration Page.

### BACKGROUND

The subject item to be insured may comprise a multitude of possibilities; however, the following application focuses on the subject item of the preferred embodiment which is real estate and more specifically residential real estate. During the purchase of residential real estate or the refinancing of a loan, one of the lender's required documents is a Declaration page to confirm that the property is adequately insured by a binding insurance policy and that the loan company is properly listed as an “Insured” so that the lender's investment is protected. A Declaration page outlines insurance coverage information in a quick, readable format and includes items such as the named insured(s) on the policy, lien-holder information (also known as mortgagee information), property location, yearly premium, and the name and address of the issuing insurance agency. Currently, however, when a home purchase or refinance takes place, the process of obtaining a Declaration page is inefficient, overly-complicated and time consuming thus often times resulting in errors and consequently delays in closing. Delays exasperate the closing even more by requiring that date specific loan documents have to be redone. In addition, interest rates may fluctuate which could adversely affect the home buyer or the lender.

Under the current system, at loan officer may refer a homebuyer to a variety of insurance agents who then collect information from the homebuyer, presents the information to the insurance companies, waits for the insurance companies to provide quotes based on the information conveyed by the agents, and then the agents provide said quotes to the homebuyer who then selects the coverage of choice and makes a payment wherein the agent then notifies the insurance company, who then will prepare and print a Declaration Page or authorize the agent to prepare and print a Declaration page. The Declaration page may be provided to the homebuyer or the loan officer to then be provided to the lender or closing attorney. Alternatively, the lender may send a page called an HOI Request to an insurance agent the lender or the buyer is familiar with.

As is obvious from the description above, there is a multitude of potential problems that could go wrong under the prior method. Even without problems, the unavailability or delay by any part of the process could result in an expediential delay of the closing. For instance, insurance agents or loan officers may be unavailable. In addition, an agent, loan officer or even the lender can make mistakes and typos when inputting the mortgagee clause or the insured's name or the property information. A mortgagee clause is the required legal name and written information required by a mortgage lender on the Declaration to protect its interest. An error in any one of these areas often results in the process being repeated thus causing further delays.

In an attempt to overcome some of these deficiencies, certain tools have been proposed to provide quotes from one or more insurance companies. None of them, however, allow the user (be it the homebuyer or their loan officer) to enter all the necessary information (i.e., mortgage company name, mortgagee clause or closing date) or to generate a Declaration page nor do any of the proposed solutions actually generate a Declaration page. Thus, a separate stage is still required wherein an agent of the insurance company or the insurance company itself must enter all the necessary information, review and then print the Declaration page. These inefficiencies regularly cause delays in home closings and sometimes even results in missing deadline dates for locked in interest rates.

One such attempt to address the aforesaid deficiencies as to the quoting process is U.S. Pat. No. 8,185,463 by Robert Ball, wherein software is implemented to provide an application that includes an interactive interface for use by insurance professionals in managing clients, marketing insurance, and storing information. It does not, however, solve the problems and inefficiencies regarding the production of the Declarations page. It is clear that there is an unmet need for a system, method and/or process that provides insurance quotes and facilitates the production and generation of the Declaration page for a purchase or refinance closing. It should be noted that although a reference may be made in this section to a patent or patent application or specific technology, nothing contained herein shall be considered an admission that said reference or said material is in fact prior art.

### BRIEF SUMMARY OF THE INVENTION

Briefly described, in a preferred embodiment, the present invention overcomes the above-mentioned disadvantages and meets the recognized need by providing a system/process/method that takes the individual insurance companies and their agents out of the process, or minimizes their involvement, in creating a Declarations page wherein the process localizes and streamlines the home buying/refinancing process and allows, in a preferred embodiment, all of the parties involved in the transaction to access the system and input relevant information pertaining to each party.

More specifically, the present invention is a system comprising the process, instructions and architecture of a graphical user interface saved on a physical, computer readable media device, wherein homebuyers and/or their loan officers and/or insurance agents can obtain insurance quotes and print and/or email Declaration pages locally as set forth in the following specification. Additionally, the present invention in its preferred embodiment will also allow the loan officer or homebuyer to directly enter the name of the mortgage company, mortgagee clause, closing date, and loan number (if required) as opposed to the current system where this is done by the insurance company employees.

The heretofore mentioned quote providing and direct Declaration page producing, printing and sending tool can also have the ability to save each lender's mortgagee clauses for ease of future use and save them all to a database that can then be searched by other users using a drop-down menu or an alphabetized search tool. This allows the users, in any combination, to provide the necessary data to obtain Insurance quotes, print locally, and then email or fax a an insurance Declaration page themselves. The present invention will:
1. Allow the homebuyer, loan officer, insurance agent or loan processor to enter the buyer's personal information, property address, closing date, mortgagee clause, mortgage company name, mortgagee address and loan number (if required) separately or in cooperation;
2. Increase the speed and efficiency by which home insurance quotes and Declaration pages are provided for closings;
3. Allow the loan officer, loan processor, insurance agent and/or homebuyer/owner to print or send an email or email attachment themselves having the Declaration page;
4. Make it easier for the loan officer or loan processor to request and obtain home insurance quotes and Declaration Pages;
5. Help more homebuyers get efficiently cleared for closing from an insurance standpoint;
6. Reduce the number of third party typographical errors on the mortgagee clause and other Declaration page information; and
7. Allow faster and more cohesive changes to coverage and or other information on the Declaration page.

### BRIEF DESCRIPTION OF THE DRAWINGS

Accordingly, the present disclosure will be understood best through consideration of, and with reference to, the following drawing Figures, viewed in conjunction with the Detailed Description of the Preferred and Selected Alternate Embodiments referring thereto, in which like reference numbers throughout the various Figures designate like structure, and in which:

FIG. 1 is a simplified flow chart of the preferred embodiment of the present invention; and

FIG. 2 is an expanded detailed flowchart of the preferred embodiment of the present invention.

It is to be noted that the figures presented are intended solely for the purpose of illustration and that they are, therefore, neither desired nor intended to limit the invention to any or all of the exact details, steps, flow or order as shown, except insofar as they may be deemed essential to the claimed invention.

### DETAILED DESCRIPTION OF THE PREFERRED AND SELECTED ALTERNATE EMBODIMENTS

In describing the preferred and selected alternate embodiments of the present invention as illustrated in the Figures and further described herein, specific terminology is employed for the sake of clarity. The claimed invention, however, is not intended to be limited to the specific terminology so selected, and it is to be understood that each specific element includes all technical equivalents that operate in a similar manner to accomplish a similar purpose.

In the preferred embodiment of the present invention, the homebuyer, loan officer, insurance agent or loan processor, using any internet-enabled device, visits a URL that hosts the system and displays it via a graphical user interface. The user registers in the system and upon confirmation that he/she is a valid user, a user-name and password for registering and secure login is generated. The user can select which type of user they are (loan officer, agent, processor or homebuyer)enter their email address and the email address of other parties involved in the process, if known, and , the property address, planned closing date, mortgage company name, mortgagee address and mortgagee clause. Although it may be preferable for this information to be entered by the loan officer or loan processor, it is contemplated that said information may be entered by the homebuyer or agent in alternate embodiments as described below. If they do not have all of the homebuyer's personal information they may choose the option of entering the homebuyer's email address and prompt the system to send an email with a link requesting the homebuyer to enter the missing information. In addition, a pre fill service can be used or property information can be obtained from the World Wide Web using pre-fill sites such as Zillow.com, Trulia.com, local county tax assessor websites or other property information gathering sites or methods. The property details (such as square footage, number of bedrooms, bathrooms, and year built, type of construction, number of stories, etc.) are used by an insurance calculator (built in the system wherein it could be provided by each insurance company quoting or outsourced to a third party), which determines what coverage is to be suggested such as dwelling, personal property, liability, loss of use, deductible, medical payments and other possible coverages desired. In addition, the loan amount and/or the homebuyer information (such as credit or claim history) can be used to determine or help determine the rate.

The comparative rater program (such as EZLYNX) would then receive the information, retrieve quotes from each insurance company by submitting the information via the World Wide Web and return each company's coverage and rates in an orderly fashion on a webpage for selection by the user. Once selected, the coverage, deductibles, premium, desired personal information, logos of the underwriting company and any other company or companies, printed or electronic signature of any desired company officials and or other desired information including how to make out the check and where to send it are compiled onto one or more pages. An option is displayed to the user to print the document (such as a print dialogue box or a simple button) or forward as an email, email attachment, or fax to any desired party or, if not the homebuyer, they can choose to send to the homebuyer for approval which will generate an email link to the home buyer who can approve or choose from the companies, rates and coverage provided. Once the homebuyer makes the selection, an email link is generated back to the loan officer or loan processor allowing them to locally print and/or forward the Declarations page. Alternatively, if the lender is authorized, the lender can just choose for the homebuyer. Other methods of distributing the Declarations page can be used. Also, a print preview can be displayed prior to printing or emailing, etc.

If the visitor is the homebuyer, they can enter all of their personal information and lien-holder information plus the closing date and any other necessary information, choose a company, coverage and rate and then enter the email address of their loan officer or loan processor and send the Declarations page via email or fax to that lender. In the preferred embodiment, if the homebuyer does not know the mortgagee clause, closing date or other information, they can enter their personal information and the loan officer or loan processor's email address and a link via the World Wide Web is automatically sent to them to complete the missing information and then print the Declarations page (or forward it by email or fax) to any other parties desired. It is understood in alternate embodiments that said link could, in addition to or in lieu of the World Wide Web, sent via a text message or other electronic means.

Following or prior to the generation of the Declarations page, in the preferred embodiment either the loan officer, loan processor, agent or homebuyer can adjust any incorrect information and reprint. In an alternate embodiment, it is possible to require approval from the homebuyer to make any changes or adjustments to coverage amounts or deductibles if subsequent to his initial is review. After any changes are made, an email is sent to each party involved notifying them of the change(s).

In the preferred embodiment, the present invention is intended to be used for homeowners insurance but in alternate embodiments, it is contemplated that other lines of insurance may be utilized.

### Additional Selected Alternate Embodiments

The mortgage company name, mortgagee clause and address, loan number (if required), closing date, property address, buyer personal information and underwriting information and questions can be input or answered by any user.
The insurance company can be added to the system to enable them to check the information generated by the system, or to add the mortgagee clause or other pertinent information.
Any missing information can be sent in list, template, form or other form to another party (meaning for example, if the homebuyer does not know the mortgagee information and or closing date, loan number, etc. then they can choose to have an email generated by the tool and sent to the loan officer or loan processor requesting they add the missing information.
A live chat feature may be added wherein an Insurance Agent could be present to assist users as desired.

The preferred embodiment creates a different, sudden and drastic change to the user experience by allowing them to enter information themselves via the World Wide Web, wherein the present invention stores said user-entered information, reaches out and collects additional information related to said user-entered information and stores same with said user-entered information on a server, and compiles and manipulates both sets of data to produce a Declaration page which is forwarded to the appropriate party (i.e., loan officer, closing attorney) via the system and/or may be printed or forwarded by the user, thus creating a much quicker and more efficient method/system for generating Declaration pages. Consequently, the present invention allows the user to reduce their dependence on other people for the purpose of obtaining a Declaration page. This invention allows loan officers, homebuyers, and loan processors more control over the process and time frame in which Declaration pages are produced. It distributes information to multiple parties allowing all parties involved to be simultaneously updated. It reduces errors made by insurance agents by allowing the lender or buyer to enter information themselves. It simplifies and speeds up the process for obtaining proof of insurance for closings, and it allows a simple means for correcting Declaration pages as is necessary.

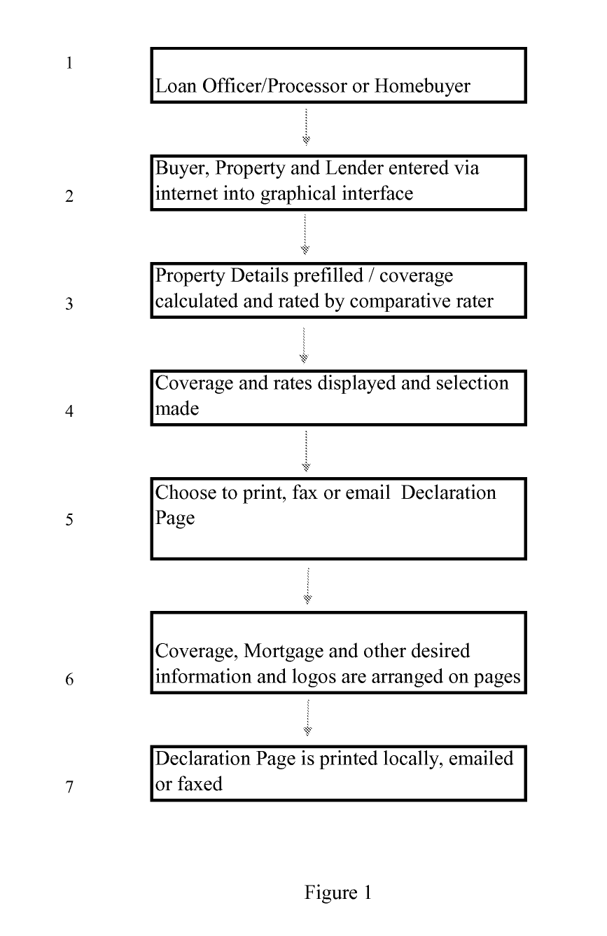

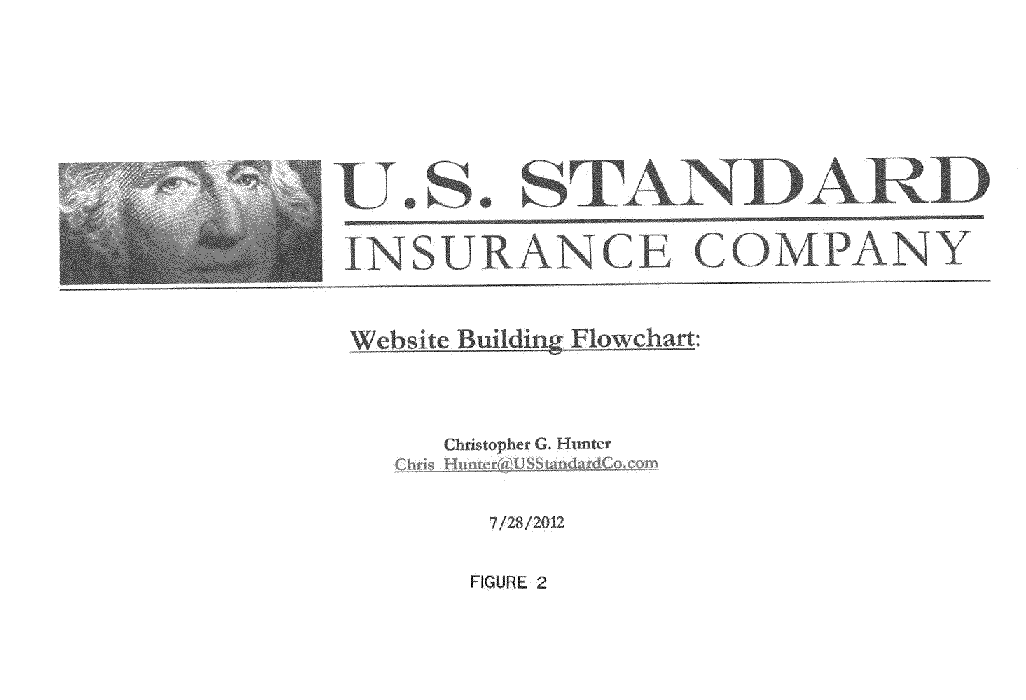

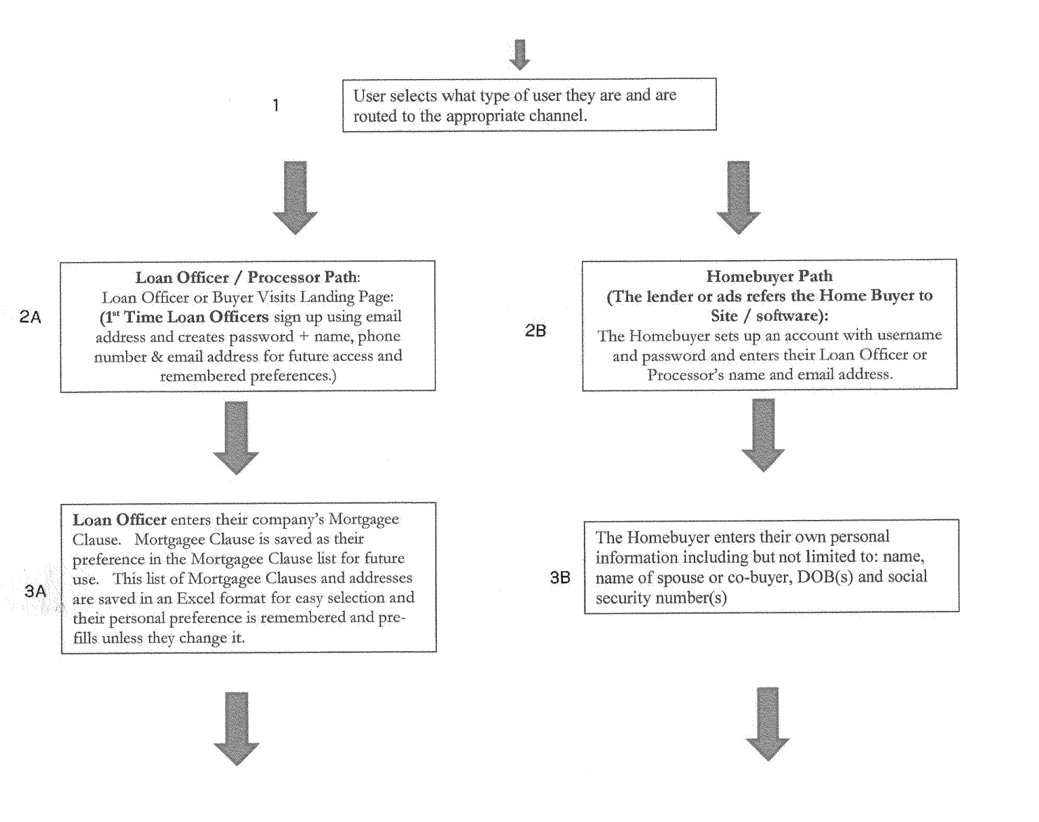

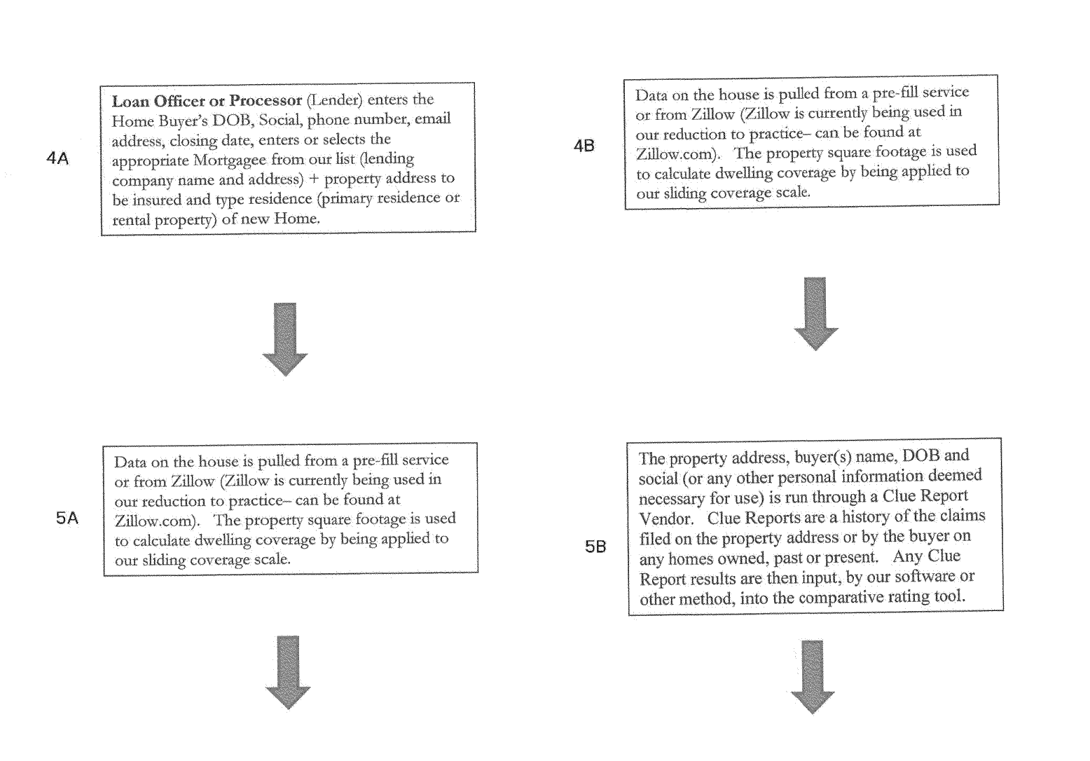

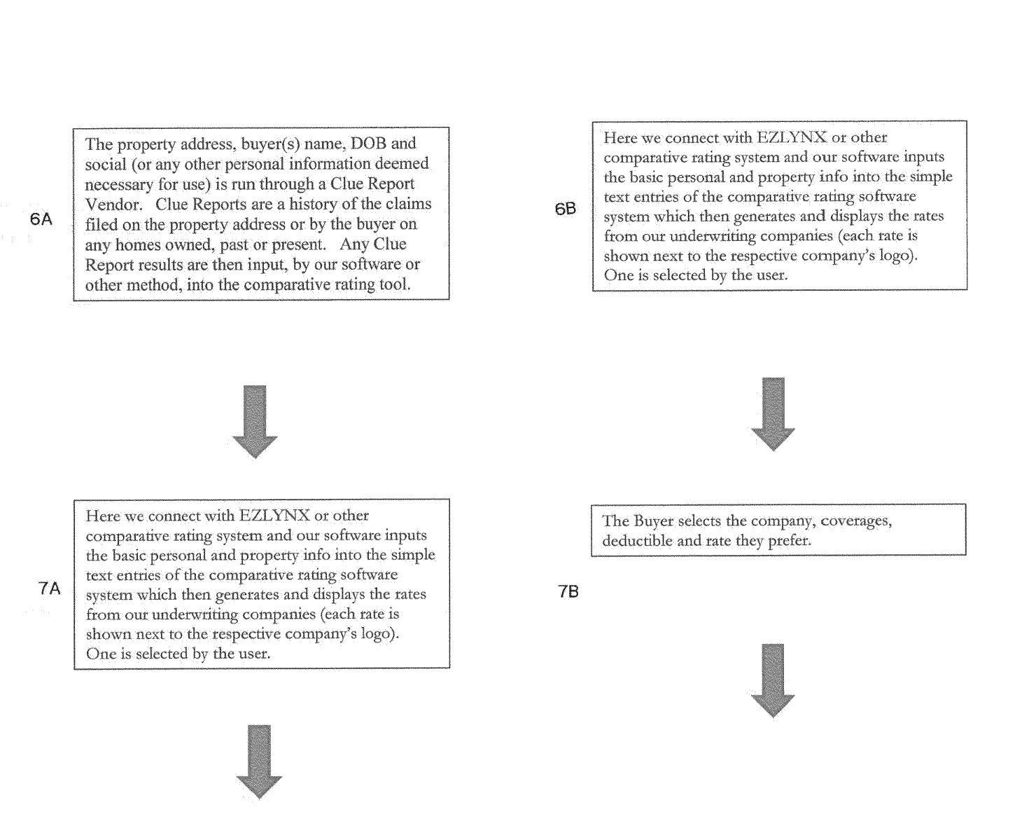

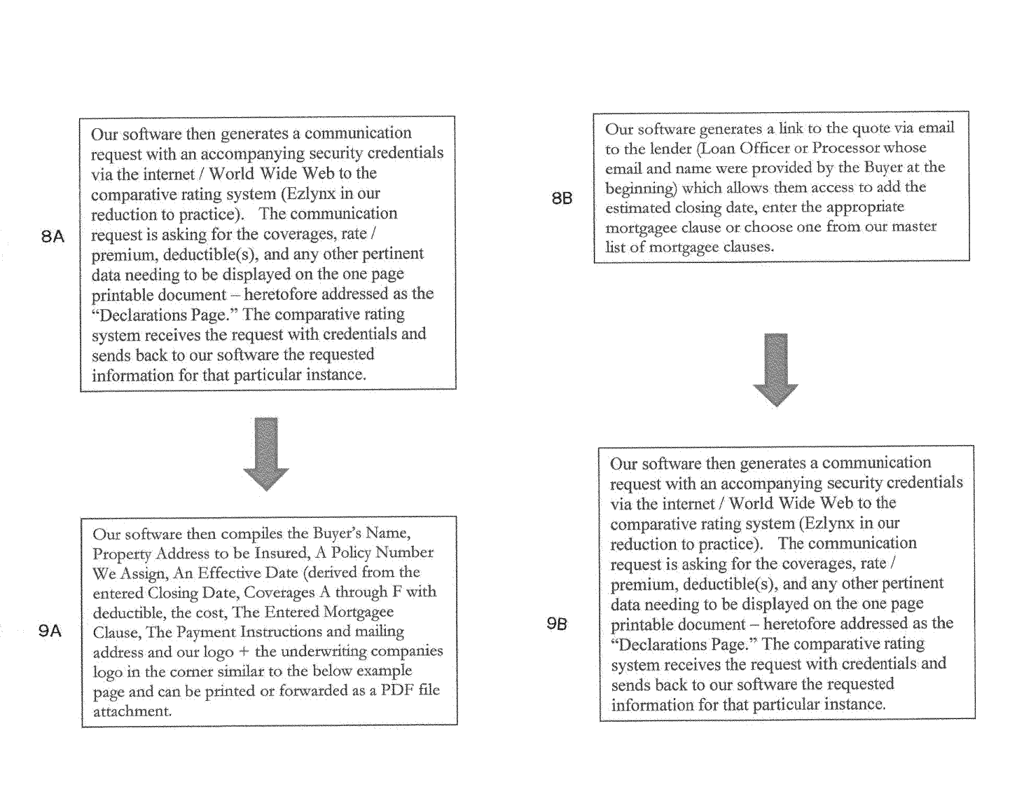

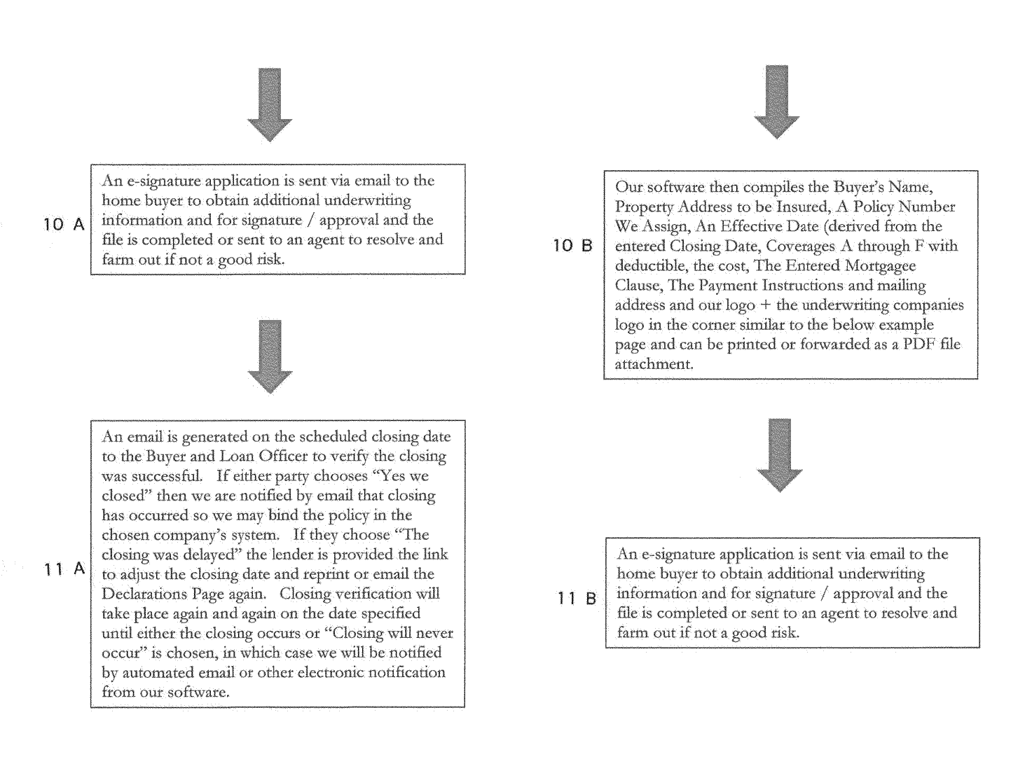

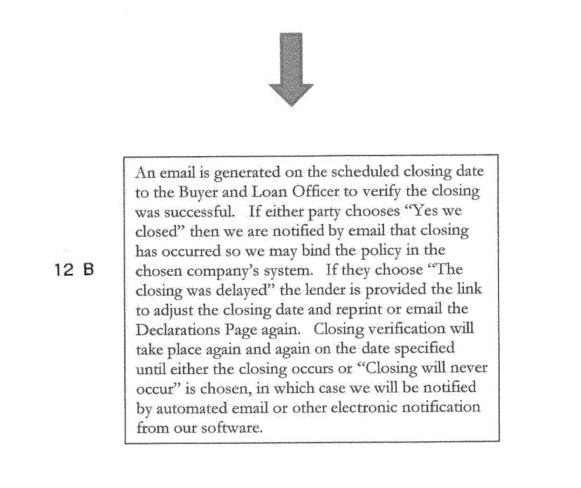

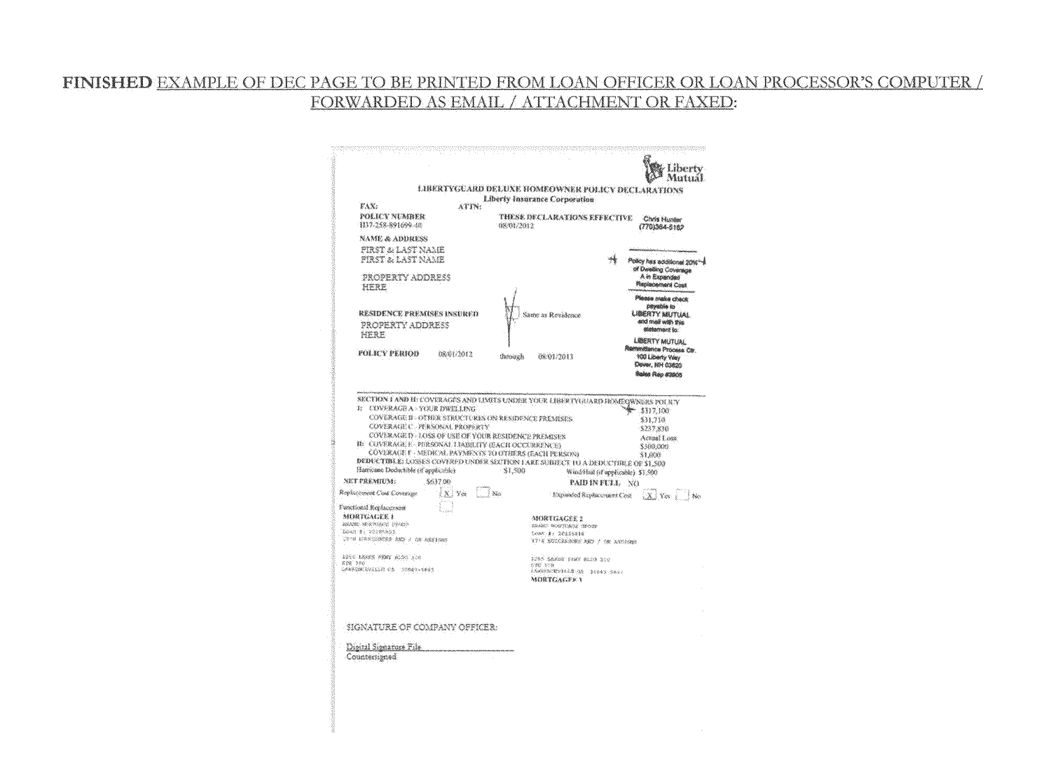

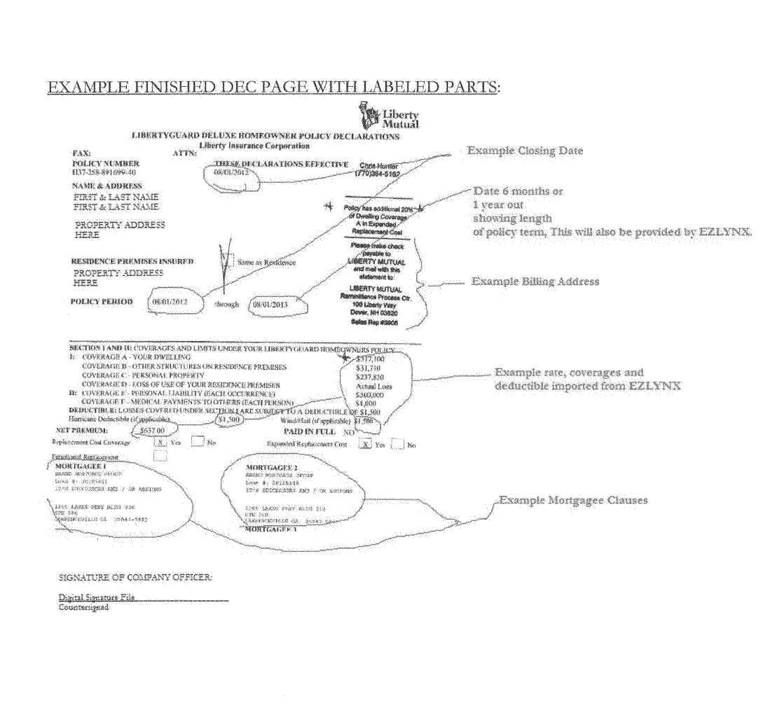

Now, referring in more detail to FIG. 1-2, FIG. 1 is a 7-step simplified flowchart of the process of the preferred embodiment of the present invention, wherein FIG. 1 identifies three types of users 1; identifies the entering of various information via a graphical interface 2; identifies property information obtained from the web and the use of comparative raters to calculate the rates 3; Identifies that quotes are displayed and a selection is made 4, identifies the selection of choices to distribute the Declaration such as printing, faxing or emailing 5; identifies the generation of the page layout of the Declaration page 6; and identifies the generation and distribution of the Declaration page 7.

Now referring to FIG. 2, a detailed flowchart of the preferred embodiment is shown wherein the type of user is separated between Homebuyer and Loan Officer/Processor. The left side of FIG. 2 shows the process for the Loan Officer or Processor and the right side follows the process of the Homebuyer. FIG. 2 includes detailed information on the typical data that is entered in each of the steps. Please note that in alternate embodiments, other information may be entered and the steps may be in different order.

In Step 1, the user indicates to the system what type of user they are and are routed to the appropriate process. In Step 2A, the Loan Officer or Processor goes to their landing page. First time users create an account, and enter their personal information. This is saved to the system. Other users enter their username and password and go on to the next module. In Step 3A, the Loan Officer or Processor enters their mortgage clause, which is saved for future reference as a preference. In Step 4A, Loan Officer or processor enters the Homebuyer's information and the property address and type of dwelling. In Step 5A, the information on the property (sq. feet, # of rooms, etc) is pulled from a known real-estate database (or one developed for the present invention) and is automatically inputted into a known comparative rating tool (or one developed for the present invention). Additional information obtained in Step 6A, wherein a Clue Report or other similar report(s) or database(s) is run, may also be included when the system inputs said information into a comparative rating tool thereby further assisting in creating the applicable rates. A Clue Report gives information on any claims filed on the property in the past and any claims the Homebuyer may have been involved in in the past. In Step 7A, the system connects with the comparative rating tool, the information is transmitted electronically and the tool generates coverage rates for different insurance companies and displays the rates on the users screen for selection. In Step 8A, once the selection has been made, the rating tool sends all of the required information back for the Declaration Page to be generated. In Step 9A, the Declaration page is generated and is ready to be printed or transmitted electronically. In Step 10A, an e-signature application is sent via e-mail to the Homebuyer and then the package goes to the insurance company. In Step 11A, an e-mail is sent to verify the closing on the scheduled date. If there was a problem with the closing the system notifies all concerned and the appropriate steps are taken.

Process B is comprised of the following steps. In Step 1, the user indicates to the system what type of user they are and are routed to the appropriate process. In Step 2B, the Homebuyer sets up an account and enters their Loan Officers e-mail address. In Step 3B, the Homebuyer enters their personal information, unless the Loan Officer or Processor has already entered it. In Step 4B, the information on the property (sq. feet, # of rooms, etc) is pulled from a known real-estate database (or one developed for the present invention) and is automatically inputted into a known comparative rating tool (or one developed for the present invention). Additional information obtained in Step 5B, wherein a Clue Report or other similar report(s) or database(s) is run, may also be included when the system inputs said information into a comparative rating tool thereby further assisting in creating the applicable rate. A Clue Report gives information on any claims filed on the property in the past and any claims the Homebuyer may have been involved in in the past. In Step 6B, the system connects with the comparative rating tool, the information is transmitted electronically and the tool generates coverage rates for different insurance companies and displays the rates on the users screen for selection. In Step 7B, the buyer selects one of the coverage options displayed. In Step 8B, the software notifies the Loan Officer or Processor, via email, to enter the closing date and mortgage clause. In Step 9B, once the selection has been made the rating tool sends all of the required information back to this invention for the Declaration Page to be generated. In Step 10B, the Declaration Page is generated. In Step 11B, an e-signature application is sent via e-mail to the Homebuyer and then the package goes to the insurance company. In Step 12B, an e-mail is sent to verify the closing on the scheduled date. If there was a problem with the closing, the system notifies all concerned and the appropriate steps are taken.

An example of a Declaration page 13 as it is generated by the tool to be printed or transmitted electronically is shown. An example of the finished Declaration page 14 with labeled parts is shown.

Although the description above contains many specificities, it should be understood in light of the present disclosure, alternate methods are contemplated and the present invention should not be limited by the embodiments presented but only by the Claims.

What is claimed is:

1. A system for generating insurance quotes and insurance Declaration pages comprised of:
a graphical interface for collecting information from a user;
a searchable data source in communication with said graphic interface that provides data regarding the object to be insured;
a means for calculating insurance rates based on said searchable data source, wherein said calculation means is in communication with said searchable data source and said graphical interface and wherein said insurance rates are displayable on said graphical interface or other media and selectable by a user;
a means for manipulating the information of said selected insurance quote and generating a Declaration page, wherein said means for manipulating is in communication with said means for calculating and said graphical interface; and
a means for distributing said Declaration page to a selectable individual and/or group, wherein said means for distributing is in communication with said graphical interface.

2. The System of claim 1, wherein said user is selected from the group consisting of owner of said object to be insured, buyer of said object to be insured, a person authorized by the owner of said object, a person authorized the buyer of said object to be insured.

3. The System of claim 1, wherein said user is at least in part a buyer.

4. The System of claim 1, wherein said user is at least in part a loan officer.

5. The System of claim 1, wherein said user is at least in part a loan processor.

6. The System of claim 1, wherein said user is someone authorized by a buyer to act on their behalf.

7. The System of claim 1, wherein said graphical interface is carried on the World Wide Web.

8. The System of claim 1, wherein said means for distributing is a printer.

9. The System of claim 1, wherein said means for distributing is email.

10. The System of claim 1, wherein said means for distributing is facsimile.

11. The System of claim 1, wherein said searchable data source is a real estate database.

12. The System of claim 1, wherein said means for calculating is a comparative rating tool.

13. A method of generating a Homeowners Insurance Declaration page for a property, comprising the steps of:
a. user enters information on an internet-enabled device;
b. information about the property is obtained through a real estate database service feed;
c. said information is inputted into a comparative rater;
d. insurance quotes are generated based on said information and presented to a user for selection;
e. a user selects desired insurance quote;
f. based on said selected insurance quote, a Declaration page is compiled; and
g. said Declaration page is distributed to a selected individual or selected group.

14. The method of claim 13, wherein said user is selected from the group consisting of owner of said object to be insured, buyer of said object to be insured, a person authorized by the owner of said object, a person authorized by the buyer of said object to be insured.

15. The method of claim 13, wherein said user is at least in part a buyer.

16. The method of claim 13, wherein said user is at least in part a loan officer.

17. The method of claim 13, wherein said user is at least in part a loan processor.

18. The method of claim 13, wherein said user is at least in part someone authorized by a buyer to act on their behalf.

19. The method of claim 13, further comprising the step of using said user entered information to search a data base of insurance claims regarding the homebuyer to get claim information.

20. The method of claim 19, wherein said claim information is used in conjunction with said property information for the comparative rater.

21. The method of claim 13, further comprising the step of automatically printing the compiled Declaration page.

22. The method of claim 13, further comprising the steps of selecting one or more individuals for receiving the Declaration page, and automatically distributing the compiled Declaration page electronically to said predetermined selection of individual(s).

23. The method of claim 13, further comprising the step of sending a link to the homebuyer to connect to the information database and enter missing or incorrect information.

24. The method of claim 23, wherein said link is sent to the homebuyer via email.

25. The method of claim 23, wherein said link is sent to the homebuyer via an instant message.
